(19) United States
(12) Patent Application Publication
(10) Pub. No.: US 2026/0070067 A1
(43) Pub. Date: Mar. 12, 2026

(54) ELECTRONICALLY ENHANCED AIR CLEANER WITH MULTIPLE FILTERS AND ENERGY GRIDS

(71) Applicant: HEALTHWAY HOME PRODUCTS COMPANY INC., Pulaski, NE (US)

(72) Inventors: Xiaoer Wei, Shenzhen (CN); Alexander Thomas Frechette, Mexico, NY (US); Yinyin Blodgett, Orwell, NY (US)

(21) Appl. No.: 19/321,418

(22) Filed: Sep. 8, 2025

Related U.S. Application Data
(60) Provisional application No. 63/691,702, filed on Sep. 6, 2024.

(51) Int. Cl. B03C 3/155; B01D 46/00; B01D 46/58; B01D 46/62; B03C 3/011; B03C 3/36

(52) U.S. Cl. CPC B03C 3/155; B01D 46/0032; B01D 46/58; B01D 46/62; B03C 3/011; B03C 3/368; B01D 2267/30; B01D 2267/40

(57) ABSTRACT

An air filtration system includes a housing defining separate first and second pathways for air to pass from outside the system through respective pluralities of filters, each plurality comprising a prefilter and an electrically enhanced filter having a high-voltage conductor, a ground grid, and filter media disposed between the conductor and grid. Energizing the high-voltage conductor establishes an electric field across the filter media to enhance particle capture. A fan is configured to draw air from outside the system concurrently through both pathways for sequential filtration.

### CROSS REFERENCE TO RELATED APPLICATION

This application claims the benefit of U.S. Provisional Application No. 63/691,702, filed Sep. 6, 2024, the disclosure of which is incorporated herein by reference in its entirety.

### FIELD OF THE DISCLOSURE

The present disclosure is generally related to the filter assemblies for air purification systems and techniques for replacing those filter assemblies and, in particular to a multidirectional air entry disinfecting filtration system.

### BACKGROUND

Various types of air filters have been made for many years. Conventional air filters pass a flow of air through a filter, where the filter traps particles that are larger than a characteristic hole size associated with the filter. With the emergence of new infectious diseases caused by various pathogens (such as coronavirus COVID-19, antibiotic resistant bacteria, and antifungal resistant fungi), the need to filter very small particles out of the air has increased dramatically. The size of viruses ranges from 20 nanometers (nm) to about 5000 nm, where COVID-19 has a diameter of about 100 nm.

However, as the hole size of a filter decreases, a resistance to the airflow due to the filter increases. Therefore, fans or pumps that force air through an air filtration system having a filter must be more powerful in order to maintain a given airflow rate when denser filters are used. Thus, increasing an amount of filtering capability by using a filter with a smaller hole size results in increased costs associated with operating or manufacturing an air filtering system, because, in general, a fan or pump will require larger amounts of power to maintain an airflow rate through a small-hole-size filter than is required to maintain the same airflow rate through a larger-hole-size filter. Alternatively, a larger, more powerful, and generally more expensive fan or pump may be required when a small-hole-size filter is used than when a larger-hole-size filter is used.

A technique that has been used to filter air, is to charge particles in an airflow using a high-voltage and then capture the charged particles on a surface that has a different or opposite charge. Such air filters are commonly referred to as ionizing or ionizer air purifiers. Ionizing air purifiers, however, generate ozone that is emitted into environments where people live and work, and people who breathe ozone commonly suffer from health effects that include chest pain, coughing, throat irritation, and congestion. Breathing ozone is also associated with various illnesses and increased rates of bronchitis, emphysema, and asthma.

Another limitation of conventional air filtering systems is that filters contained within such systems can be difficult to replace. Tools such as a screwdriver or wrench are often required to access and replace a filter, such that parts such as screws or nuts that must be removed to replace a filter may be lost and this may result in air passing around instead of through an air filter system or portions thereof. In addition, design of an air filtration system may require that filters are located in positions that are difficult to access, thus making replacement of the filters difficult, cumbersome, and time-consuming.

Another limitation of conventional air filtering systems is that to generate a desired air filtering capacity, air filtration equipment at times needs to be rather large, which can prove to be ungainly in certain applications and implementations and may result in the equipment being difficult to move or to adapt to fixed room or environmental configurations.

It is therefore desirable to provide an air purification system in a relatively compact and adaptable form factor, which can continuously capture very fine particles and live organisms, while minimizing the expense of the fans and pumps used to force air through filters of the air purification system. Additionally, it is desirable to configure the filters such that they are easy to access and replace.

### SUMMARY

In some aspects, the techniques described herein relate to an air filtration system including: a housing that defines a first pathway for air to pass from outside the system and through a first plurality of filters, and a second pathway for air to pass from outside the system and through a second plurality of filters. Each of the first plurality of filters and the second plurality of filters includes a prefilter and an electrically enhanced filter, the electrically enhanced filter including a high-voltage conductor, a ground grid and filter media disposed between the high-voltage conductor and the ground grid. An electric field is created between the high-voltage conductor and the ground grid when the high-voltage conductor is energized to a high-voltage. The system includes a fan configured to draw air from outside the system along the first and second pathways.

Implementations can include one or more of the following features, alone, or in any combination with each other.

For example, in some implementations, the first pathway is opposite to the second pathway.

For example, in some implementations, the housing further defines a third pathway along which air that has passed along the first pathway through the first plurality of filters and air that has passed along the second pathway through the second plurality of filters is exhausted from within the system to outside the system.

For example, in some implementations, the third pathway is orthogonal to the first pathway and to the second pathway.

For example, in some implementations, the system further includes one or more power supplies configured for providing a high-voltage to the high-voltage conductor of the electrically enhanced filter of the first plurality of filters and to the high-voltage conductor of the electrically enhanced filter of the second plurality of filters.

For example, in some implementations, the high-voltage provided to the high-voltage conductors creates a first electric field of greater than 2 kV/cm between the high-voltage conductors and the ground grids.

For example, in some implementations, the high-voltage provided to the high-voltage conductor creates a first electric field of greater than 2 kV/cm and less than 10 kV/cm between the high-voltage conductors and the ground grids.

For example, in some implementations, each of prefilters of the first plurality of filters and of the second plurality of filters includes the high-voltage conductor of the respective plurality of filters, a grounded entry grid, and prefilter media disposed between the high-voltage conductor and the grounded entry grid, and where the high-voltage provided to the high-voltage conductors of the respective plurality of filters creates a first electric field of greater than 2 kV/cm between the high-voltage conductor and the ground grid and creates a second electric field of less than 2 kV/cm between the high-voltage conductor and the grounded entry grid in the respective plurality of filters.

For example, in some implementations, each of the plurality of filters further includes an intermediate grid located between the high-voltage conductor and the grounded entry grid of the respective plurality of filters, and the intermediate grid is maintained at a voltage that is higher than ground and lower than the voltage on the high-voltage conductor of the respective plurality of filters.

In some aspects, the techniques described herein relate to a method of filtering air, the method including: in a housing that defines a first pathway for air to pass from outside the housing and through a first plurality of filters, and that defines a second pathway for air to pass from outside the housing and through a second plurality of filters, where each of the first plurality of filters and the second plurality of filters includes a prefilter and an electrically enhanced filter, the electrically enhanced filter including a high-voltage conductor, a ground grid and filter media disposed between the high-voltage conductor and the ground grid, applying a high-voltage potential to high-voltage conductor of each of the plurality of filters to create a first electric field between the high-voltage conductor and the ground grid in each of the plurality of filters; and drawing air from outside the housing along the first and second pathways.

Implementations can include one or more of the following features, alone, or in any combination with each other.

For example, in some implementations, the first pathway is opposite to the second pathway.

For example, in some implementations, the housing further defines a third pathway along which air that has passed along the first pathway through the first plurality of filters and air that has passed along the second pathway through the second plurality of filters is exhausted from within the housing to outside the system.

For example, in some implementations, the third pathway is orthogonal to the first pathway and to the second pathway.

For example, in some implementations, the first electric field is greater than 2 kV/cm between the high-voltage conductors and the ground grids.

For example, in some implementations, the first electric field is greater than 2 kV/cm and less than 10 kV/cm between the high-voltage conductors and the ground grids.

For example, in some implementations, each of prefilters of the first plurality of filters and of the second plurality of filters includes the high-voltage conductor of the respective plurality of filters, a grounded entry grid, and prefilter media disposed between the high-voltage conductor and the grounded entry grid, and where the high-voltage provided to the high-voltage conductors of the respective plurality of filters creates a second electric field of less than 2 kV/cm between the high-voltage conductor and the grounded entry grid in the respective plurality of filters.

For example, in some implementations, each of the plurality of filters further includes an intermediate grid located between the high-voltage conductor and the grounded entry grid of the respective plurality of filters, and the method further including maintaining the intermediate grid at a voltage that is higher than ground and lower than the voltage on the high-voltage conductor of the respective plurality of filters.

### BRIEF DESCRIPTIONS OF THE DRAWINGS

FIG. 1 is an exploded perspective view of an air filtration system that includes a plurality of electrically enhanced filters configured for filtering air from an environment around the system.

FIG. 2 illustrates a portion of the air filter apparatuses of FIG. 1, which includes parts that provide a high energy field and that isolate the field from external parts of an air filter apparatus.

FIG. 3 is a schematic diagram of an air filtration system having at least two pathways for air to pass from outside the system, through the system, and back outside the system, where each of the pathways includes a prefilter and an electrically enhanced filter.

FIG. 4 is a schematic diagram of a filtration system having at least two pathways for air to pass from outside the system, through the system, and back outside the system, where each of the pathways includes an electrically enhanced prefilter and an electrically enhanced main filter media.

### DETAILED DESCRIPTION

A disinfecting filtration system (DFS), also referred to as electrically enhanced filtration (EEF), is an air purification system that uses two mechanisms to maintain high air cleaning performance. An EEF air purification system may use a high energy field to facilitate the aggregation and capture of airborne particles. Such a system may effectively increase particle size by forming clusters of particles. Such a high energy field may be controlled in a manner that contains and captures charged particles without emitting charged particles from the filter system. Such a filtering process may be based on an “entry ground control grid” that is located before a front part of a main filter and a “rear control grid” (or “exhaust control grid”) that may be affixed to a rear part of the main filter. The entry ground control grid and the rear/exhaust control grid may be tied to a ground, or Earth, connection that prevents these grids from being energized by the high energy field. Each of the entry ground control grid and rear/exhaust control grid may include a screen that includes holes that do not allow service personnel to reach into an energized portion of a disinfecting filtration system.

Even in instances where ions are generated by the high energy field, such charged particles are isolated in the main filter between the entry control grid and the rear/exhaust control grid on a rear side of the filter. The controlled, isolated high energy field generated by the EEF continually creates high energy exposure through pleats and fibers of a main filter creating a microbiostasis (“prevention of organism growth”) in the main filter. This may prevent live organisms from escaping back into the air. These two mechanisms work together to provide the ultraclean filtration of particles as well as continual prevention of organism growth in the EEF filter.

One or more prefilters, located upstream of the main filter, can be used to remove larger particles and may increase the effective lifespan of electrically enhanced filters and reduce the mechanical and/or electrical load placed on the system caused by the drop in air pressure between an upstream and downstream side of the main filter as air is pushed through the main filter by a fan. In some implementations, prefilters are replaced more frequently than the electrically enhanced filters, as failure to do so may limit the effectiveness of the air filtration system and increase the pressure drop across the main filter. The replacement of prefilters and main filters should be as simple a process as possible, and ideally require little to no expertise.

To generate a desired air filtering capacity, air filtration equipment at times needs to be rather large, which can prove to be ungainly in certain applications and implementations and may result in the equipment being difficult to move or difficult to adapt to fixed room or environment configurations.

It is therefore desirable to provide an air purification system in a relatively compact and adaptable form factor, which can continuously capture fine particles and live organisms while maintaining a low pressure drop across the filters.

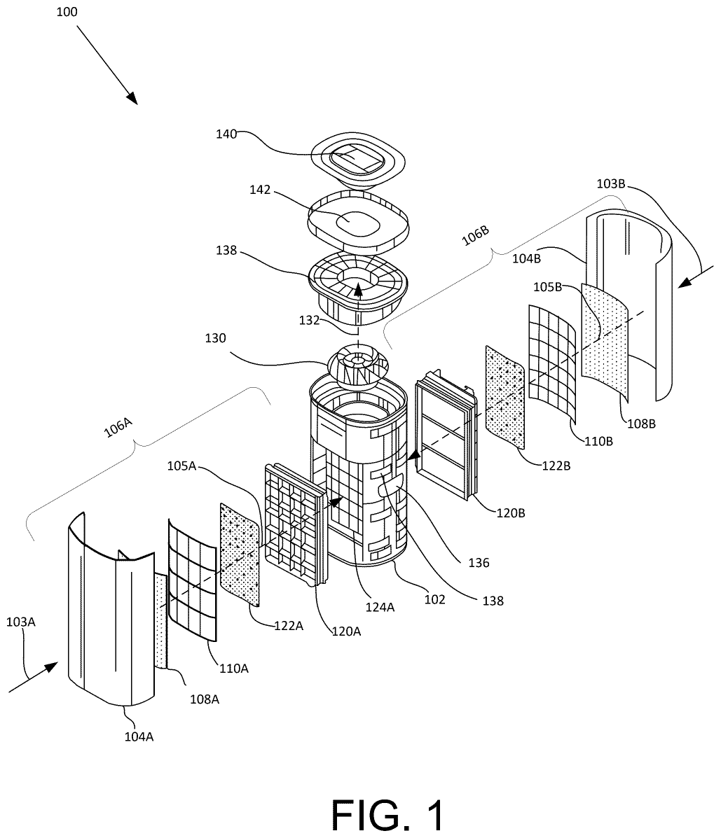

FIG. 1 is an exploded perspective view of an air filtration system 100 that includes a plurality of electrically enhanced filters configured for filtering air from an environment around the system 100. Air from an environment around the system can enter the system 100 from different directions, for example, from opposite directions 103A, 103B, and then can pass through filters within the system along different pathways 105A, 105B (e.g., in opposite directions), and then can be exhausted from the system back into the environment. The system 100 can include an inner housing 102 and an outer shell 104A, 104B that encloses the inner housing. In some implementations, the outer shell can include a first outer shell portion 104A and a second outer shell 104B opposite the first outer shell portion 104A.

On a first side 106A of the system 100, a plurality of filters can be located between the first outer shell portion 104A and the inner housing 102. For example, the plurality of filters on the first side 106A of the system 100 can include a prefilter 108A and a main filter 120A. The prefilter 108A can be supported within the system 100 by a prefilter frame 110A, which, in some implementations, can include a rigid or semi-rigid structure that mechanically supports the prefilter 108A and locates the prefilter within the system between the outer shell portion 104A and the inner housing 102. The prefilter 108A can be a passive (e.g., non-electrically enhanced) filter that filters an airflow that passes through the prefilter 108A to capture particles in the air that are larger than a characteristic hole size of the prefilter. In some implementations, the prefilter 108A can be an active (e.g., electrically enhanced) filter that filters an airflow that passes through the prefilter 108A.

The plurality of filters on the first side 106A of the system 100 also can include a main filter 120A that can be an electrically enhanced filter. The main filter 120A can include a layer of dense material having small openings that define air passageways through the layer of material where the openings have a characteristic size (e.g., cross-sectional area) that traps particles that are larger than the characteristic size. Particles suspended in the air that enters the system 100 through the first outer shell portion 104A can be clustered together to form composite particles by the application of an electric field in, or near, the main filter 120A, where the composite particles of a cluster are larger than the individual particles in the cluster. By creating clusters of particles that are larger than individual particles, the characteristic size of openings in the layer of dense material in the main filter can be relatively large, while still having the ability to trap significant amounts of particulate matter in the air that passes through the main filter. This is because the particulate matter is formed into relatively large clusters that can be trapped by the relatively large openings in the layer of dense material. With openings having a relatively large characteristic size, the layer of dense material in the main filter provides less resistance to air than a similar layer of dense material having openings with a smaller characteristic size, thereby reducing a load on a fan that pushes air through the layer or dense material.

In some implementations, the system can include an electrically-conductive high-voltage grid 122A to which a high-voltage can be applied. The grid 122A can include a grid, frame, array, or regular pattern of electrically-connected structures (e.g., wires or rods) to which a high-voltage (e.g., greater than 1000 V, greater than 3000 V, or greater than 10,000V) can be applied. In some implementations, the prefilter frame 110A and the inner housing 102 can be electrically-connected to ground, so that when a high-voltage is applied to the conductive high-voltage grid 122A a strong electric field is created between the grid and the prefilter frame 110A and between the grid 122A and the inner housing 102. For example, the prefilter frame 110A can act as an entry ground control grid, and, in some implementations, the inner housing 102 can include an electrically-conductive grid 124A connected to ground, which acts as a rear control grid. With the main filter 120A being located between the high-voltage grid 122A and the grid 124A of the inner housing, the strong electric field is created within the main filter 120A, where the electric field effectively increases the particle size of contaminants in the air that passes through the system 100 by forming clusters of ultrafine particles.

As explained above, in some implementations, the material of the electrically enhanced main filter 120A may include a less dense media (for example, 97 DOP) compared to a standard high efficiency particulate air (HEPA) filter (99.97 DOP). The DOP rating of a filter refers to how efficiently it removes dispersed oil particulate (DOP), which is a standardized aerosol used in testing, at a specific particle size, typically 0.3 microns, where the testing measures the percentage of these particles the filter can capture.

The use of a less dense filter media may allow the air filtration system 100 to have a higher gram holding weight and allows for more dust holding capacity than a standard HEPA filter, resulting in increased filter life. HEPA filters also offer higher air flow resistance as compared to the less dense media used in the main filter 120A. The main filter 120A can be continually being exposed to a high energy field, creating a microbiostatis effect in the media of the filter. The result, depending on the efficiency of the traditional media used, is as follows: much higher particulate efficiency than traditional media filters and with fan-powered machines, a up to 99.99% at 0.002-micron filtration efficiency, with a greater gram holding weight capacity, resulting in a greater lifetime performance and less maintenance and energy cost.

Similar to the first side 106A of the system 100, on a second side 106B of the system 100, a plurality of filters can be located between the second outer shell portion 104B and the inner housing 102. For example, the plurality of filters on the second side 106B of the system 100 can include a prefilter 108B and a main filter 120B. The prefilter 108B can be supported within the system 100 by a prefilter frame 110B, which, in some implementations, can include a rigid or semi-rigid structure that mechanically supports the prefilter 108B and locates the prefilter within the system between the outer shell portion 104A and the inner housing 102. The prefilter 108B can be a passive filter or an active filter that filters an airflow that passes through the prefilter 108A to capture particles or clusters of particles in the air that are larger than a characteristic hole size of the prefilter.

The plurality of filters on the second side 106B of the system 100 also can include a main filter 120B that can be an electrically enhanced filter. The main filter 120B can include a layer of dense material having small openings that define air passageways through the layer of material where the openings have a characteristic size (e.g., cross-sectional area) that traps particles that are larger than the characteristic size. Particles suspended in the air that enters the system 100 through the second outer shell portion 104B can be clustered together to form composite particles by the application of an electric field in, or near, the main filter 120B, where the composite particles of a cluster are larger than the individual particles in the cluster.

To filter the air passing through the second side 106B of the system 100, the system can include an electrically-conductive high-voltage grid 122B to which a high-voltage can be applied. The grid 122B can include a grid, frame, array, or regular pattern of electrically-connected structures (e.g., wires or rods) to which a high-voltage (e.g., greater than 1000 V, greater than 3000 V, or greater than 10,000V) can be applied. The prefilter frame 110B and the inner housing 102 can be electrically-connected to ground, so that when a high-voltage is applied to the conductive high-voltage grid 122B a strong electric field is created between the grid and the prefilter frame 110B and between the grid 122B and the inner housing 102. For example, the prefilter frame 110B can act as an entry ground control grid, and, in some implementations, the inner housing 102 can include an electrically-conductive grid connected to ground, which acts as a rear control grid. In some implementations, the grid 124A within the inner housing 102 can be used to create the electric fields on in both the main filter 120A on the first side 106A of the system 100 and in the main filter 120B on the second side 106B of the system. In some implementations, a second grounded grid (not shown) within the inner housing 102 on the second side of the system 100 can be used to create the electric field in the main filter 120B on the second side 106B of the system 100. The strong electric field is created within the main filter 120B effectively increases the particle size of contaminants in the air that passes through the system 100 by forming clusters of ultrafine particles.

Air can be drawn into the system 100 through the first and second outer shell portions 104A, 104B by a fan 130. In some implementations, the fan 130 can blow air out of the inner housing 102 in a direction 132 having a component that is orthogonal to the pathways 105A, 105B along which air passes through the filters 108A, 120A, 108B, 120B from outside the system 100 to the inner housing 102. By blowing air out of the inner housing 102 in the direction 132, a partial vacuum is created within the inner housing, which draws air into the system 100 along pathways 105A, 105B and through the filters 108A, 120A, 108B, 120B. The air that is blown out of the inner housing 102 by the fan 130 can be exhausted to the environment through an air outlet 142 that can include a plurality of vents that direct the exhausted air in different directions.

The system 100 can further include a high-voltage power supply 136 that is configured to supply a high-voltage potential to the high-voltage grids 122A, 122B, a processor 138 configured for executing instructions to control the power supply 136 and to control the fan 130, and a user interface 140 (e.g., a touchscreen user interface) for a user to interact with the processor 138.

With the system 100 configured to have air enter from different directions 103A, 103B and pass though different combinations of filters (e.g., filters 108A, 120A and filters 108B, 120B) along different pathways, the effective area of the filters that is available to filter air is increased (e.g., doubled), as compared with a filter system in which air passes through one or more filters along only a single pathway, because the filter surfaces of both sets of filters 108A, 120A and 108B, 120B are available to filter air. Moreover, the increase in effective filter area is achieved without doubling the overall size of the system 100, as compared with a single pathway system. In addition, the increase in effective filter area is achieved without doubling a cost of the system 100, because the system can be operated with a just a single fan 130 that creates airflow along the two different pathways and with a single power supply that supplies both main filters 120A, 120B with high-voltage and with housing components that support both sets of filters.

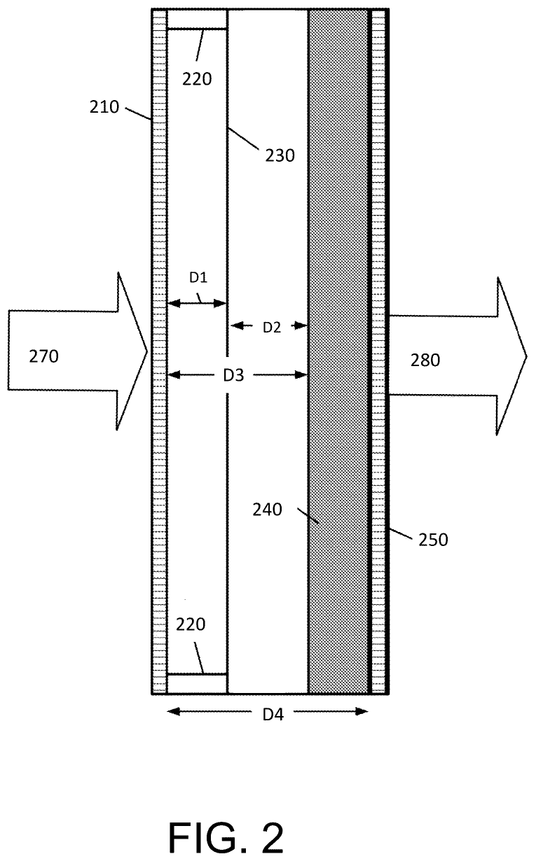

FIG. 2 illustrates a portion of the air filter apparatuses of FIG. 1, which includes parts that provide a high energy field and that isolate the field from external parts of an air filter apparatus. The portion includes a front control grid 210, insulators 220, at least one high energy wire 230, filter media 240, and a rear control grid 250. Large arrow 270 illustrates a flow of air moving into the front control grid 210 and large arrow 280 illustrates filtered air moving past the rear control grid 250. While FIG. 2 illustrates air flows 270 and 280 moving from a left side to a right side of a filter assembly, for example, along pathway 105A in the system 100 of FIG. 1, the filter assembly of FIG. 2 may be oriented in any direction and it can be used in pathway 105B of system 100, as well.

Both the front ground control grid 210 and the rear control grid 250 may be grounded such that these control grids will not become electrically charged. The one or more wires 230 or a wire mesh, which can correspond to the high-voltage grids 122A, 122B of system 100, may be energized with a high-voltage to form a high energy field within areas where arrows D1, D2, D3, and D4 are located. Arrow D1 indicates a distance between from the front control grid 210 to the one or more wires 230. Arrow D2 indicates a distance between one or more wires 230 and filter media 240. Distances D1 plus D2 equal distance D3. Note that in FIG. 2 distance D1 is a shorter distance than distance D2. By making distance D1 shorter than distance D2, any electric arcing between the one or more wires 230 and a ground connection will more likely to arc to the front control grid 210 and not the rear control grid 250. Such a design will help prevent arcing from damaging the filter media 240. Distance D4 may be identified by adding distances D1, D2, D3, and a thickness of the filter media 240. In operation, the insulators 220 electrically isolate the one or more wires 230 from other parts of the filter assembly.

The high-voltage potential of applied to the high-voltage wire 230 and the distances, D1 and (D4 minus D1) can selected to generate an electric field in a first region between the high-voltage wire 230 and the front control grid 210 and in a second region between the high-voltage wire 230 and the rear control grid 250 that is sufficient to cause the clustering of fine particles present in the first and second regions due to electrostatic forces between the fine particles, so that clusters that have a characteristic size larger than that of the fine particles are generated, such that the clusters can be trapped in the relatively porous filter media 240. For example, in some implementations, the electric field strength in the first region and in the second region can be greater than 2 kV per centimeter, for example, between about 2 kV per centimeter and about 10 kV per centimeter, which may be sufficient to cause a corona discharge near the high-voltage wire 230, which in turn may negatively charge some fine particles and positively charge some fine particles, thus leading to the clustering of fine particles due to attractive electrostatic forces between the particles. In some implementations, the electric field strength in the first region and in the second region can be between about less than 3 kV, for example, between about 300 V per centimeter and about 2 kV per centimeter, which may cause little or no corona discharge near the high-voltage wire 230, but which may be sufficient to electrically polarize fine particles and the filter media 240, such that the fine particles may be attracted to each other due to a dipole-dipole interaction between the particles that causes the particles to clump together to form larger-sized clusters, and such that the clusters are electrically attracted to the filter media 240.

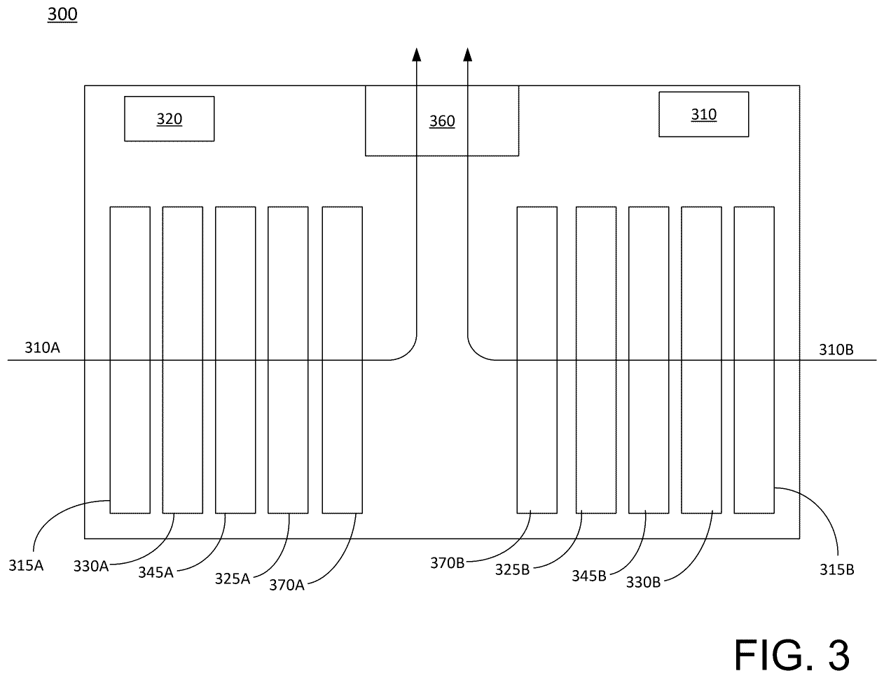

FIG. 3 is a schematic diagram of a filtration system 300 having at least two pathways 310A, 310B for air to pass from outside the system, through the system, and back outside the system, where each of the pathways includes a prefilter 315A, 315B and an electrically enhanced filter. The electrically enhanced filter in each pathway can include an entry control grid 330A, 330B, a high-voltage grid 345A, 345B, filter media 325A, 325B, and a rear control grid 370A, 370B. The system 300 includes a fan 360 configured to draw air from outside the system along the first and second pathways 310A, 310B. The system of FIG. 3 may include electronic circuits (e.g., a controller 310) that changes voltages provided to parts of the filtration apparatus 300 when air is filtered, and a power supply 320 configured to provide high-voltage energy to high-voltage wires or grids 345A, 345B. The electrically enhanced filter media 325A, 325B can be located along respective pathways 310A, 310B between the respective high-voltage wire or grid 345A, 345B and a rear ground control grid 370A, 370B.

The filtration system 300 may include several different filter assemblies including, for example, one or more passive filters, and one or more active, electrically-enhanced filters. Prefilters 315A, 315B may be filters that capture large particles before they enter the electrically enhanced filters 325A, 325B. In some implementations, the prefilters 315A, 315B may be selected to capture particles larger than a particular size, for example, prefilters 315A, 315B may be selected to provide a minimum efficiency reporting filtration value (MERV) rating of at least MERV 8. The minimum size of particles captured by the prefiltration process can vary depending upon a given application, a desired air flow, and/or a resistance to the air flow capacity of the system 300.

The electrically enhanced filters can include high-voltage wires or grids 345A, 345B, an entry control grid 330A, 330B, a high energy transfer grid 345A, 345B, and a rear control grid 370A, 370B. The entry control grids 330A, 330B may include a surface similar to a screen, chicken wire, or a plate perforated with holes that prevents a person from touching high energy wires 345A, 345B or other energized components (e.g. the high energy transfer grid) within the system 300. The rear control grids 370A, 370B also may include a surface similar to a screen, chicken wire, or perforated plate, and the entry control grid and rear control grid may be grounded. The high energy wires or grids 345A, 345B may be charged to a high-voltage, and these grids may be located in close proximity to filter media elements 325A, 325B included in the system 300.

Power may be routed to high energy wires or grids 345A, 345B of an electrically-enhanced filters from a power supply 320 that may be controlled by the controller 310. Power supply 320 may activate a high energy field by delivering a voltage to a high-voltage contact or wires connected to high energy wires or grids 345A, 345B. Voltages provided to the high energy wires or grids 345A, 345B may be high enough to generate a high energy field that is provided to the filter media 325A, 325B inside the system 300, such that an electric field gradient is generated between a high energy wires or grids 345A, 345B and the rear control grids 370A, 370B.

In some implementations, the filter media 325A, 325B may have a lower density (for example, 95 DOP) than a standard HEPA filter (99.97 DOP). This relatively low media density may allow the filter media to have a higher gram holding weight and thus allow the filter media to hold more dust as compared to a standard HEPA filter. The high energy field provided to the filter media may allow for a less dense filter media to capture smaller particles based on clumping effects associated with the design of the system 300 and the electric field generated inside the system 300. Because of this, and because of the prefilter, each of the filters included in the system 300 may have an increased usable lifespan. Furthermore, HEPA filters have a higher resistance to airflow, as compared to the filter media 325A, 325B that use lesser dense media. Therefore, a filter system 300 consistent with the present disclosure may filter as, or more, effectively than a HEPAn filtration system while providing benefits of less pressure drop across the filter media and/or lower energy use. For example, at a time of installation, a HEPA system may experience a pressure drop of 2.0 inches of mercury as compared a pressure drop of 0.25 to 0.30 inches of mercury of a DFS or EEF filtration system 300.

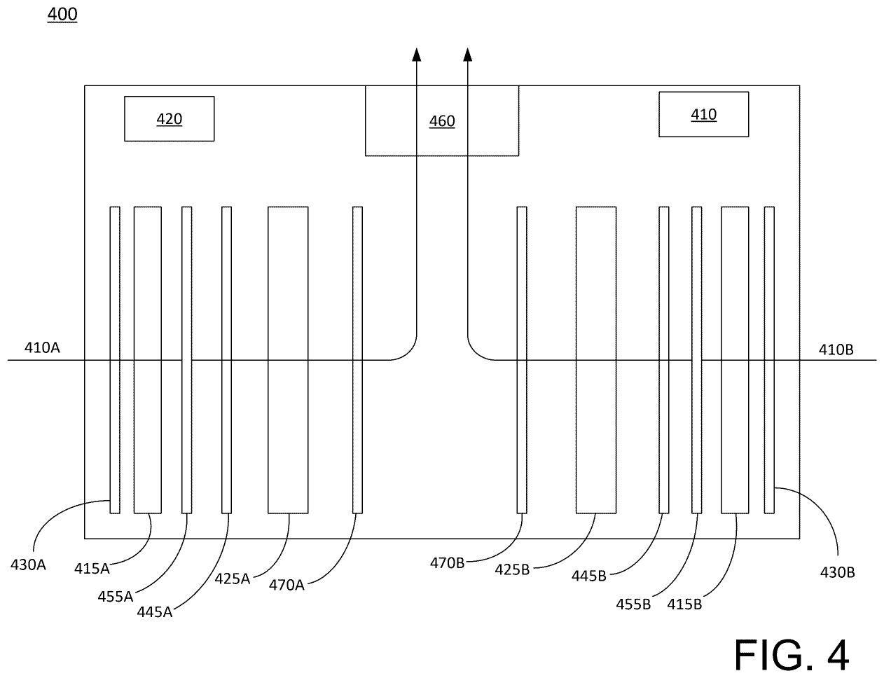

FIG. 4 is a schematic diagram of a filtration system 400 having at least two pathways 410A, 410B for air to pass from outside the system, through the system, and back outside the system, where each of the pathways includes an electrically enhanced prefilter 415A, 415B and an electrically enhanced main filter media 425A, 425B. The electrically enhanced main filter in each pathway can include an entry control grid 430A, 430B, a high-voltage grid 445A, 445B, filter media 425A, 425B, and a rear control grid 470A, 470B. The system 400 includes a fan 460 configured to draw air from outside the system along the first and second pathways 410A, 410B. The system 400 of FIG. 4 may include electronic circuits (e.g., a controller 410) that change voltages provided to parts of the filtration apparatus 400 when air is filtered, and a power supply 420 configured to provide high-voltage energy to high-voltage wires or grids 445A, 445B. The electrically enhanced filter media 425A, 425B can be located along respective pathways 410A, 410B between the respective high-voltage wire or grid 445A, 445B and a rear ground control grid 470A, 470B.

The filtration system 400 may include several different filter assemblies including, for example, one or more active, electrically-enhanced prefilters 415A, 415B that may capture large particles before they enter the electrically enhanced filters 425A, 425B. In some implementations, the prefilters 415A, 415B may be selected to capture particles larger than a particular size, for example, prefilters 415A, 415B may be selected to provide a minimum efficiency reporting filtration value (MERV) rating of at least MERV 8. The minimum size of particles captured by the prefiltration process can vary depending upon a given application, a desired air flow, and/or a resistance to the air flow capacity of the system 400. The electrically-enhanced prefilters 415A, 415B can be located in a region of a high electric field between the high-voltage wire or grid 445A, 445B and the entry control grids 430A, 430B. In some implementations, an intermediate grid 455A, 455B can be located between the high-voltage wire or grid 445A, 445B and the entry control grid 430A, 430B and can be maintained at a voltage that is higher than ground and lower than the voltage on the high-voltage wire or grid 445A, 445B. The voltage on the intermediate grid 455A, 455B can be controlled to create an electric field in the region, where the prefilter 415A, 415B is located, between the intermediate grid 455A, 455B and the entry control grid 430A, 430B. The electric field in this region may be different from (e.g., lower than) the electric field in the region between the high-voltage wire or grid 445A, 445B and the intermediate grid 455A, 455B and different from the electric field in the region between the high-voltage wire or grid 445A, 445B and the rear ground control grid 470A, 470B. In some implementations the electric field in the region of the prefilters 415A, 415B can be below a threshold voltage that would cause corona discharge, while an the electric field in the region between the high-voltage wire or grid 445A, 445B and the intermediate grid 455A, 455B and an the electric field in the region between the high-voltage wire or grid 445A, 445B and the rear ground control grid 470A, 470B can be above a threshold voltage that would cause corona discharge.

The entry control grids 430A, 430B may include a surface similar to a screen, chicken wire, or a plate perforated with holes that prevents a person from touching high energy wires 445A, 445B or other energized components (e.g. the high energy transfer grid) within the system 400. The intermediate grids 455A, 455B and the rear control grids 470A, 470B also may include a surface similar to a screen, chicken wire, or perforated plate, and the entry control grid and rear control grid may be grounded. The high energy wires or grids 445A, 445B may be charged to a high-voltage, and these grids may be located in close proximity to filter media elements 425A, 425B included in the system 400.

Power may be routed to high energy wires or grids 445A, 445B of an electrically-enhanced filters from a power supply 420 that may be controlled by the controller 410. Power supply 420 may activate a high energy field by delivering a voltage to a high-voltage contact or wires connected to high energy wires or grids 445A, 445B. Voltages provided to the high energy wires or grids 445A, 445B may be high enough to generate a high energy field that is provided to the filter media 425A, 425B inside the system 400, such that an electric field gradient is generated between a high energy wires or grids 445A, 445B and the rear control grids 470A, 470B.

In some implementations, the filter media 425A, 425B may have a lower density (for example, 95 DOP) than a standard HEPA filter (99.97 DOP). This relatively low media density may allow the filter media to have a higher gram holding weight and thus allow the filter media to hold more dust as compared to a standard HEPA filter. The high energy field provided to the filter media may allow for a less dense filter media to capture smaller particles based on clumping effects associated with the design of the system 400 and the electric field generated inside the system 400. Because of this, and because of the prefilter, each of the filters included in the system 400 may have an increased usable lifespan. Furthermore, HEPA filters have a higher resistance to airflow, as compared to the filter media 425A, 425B that use lesser dense media. Therefore, a filter system 400 consistent with the present disclosure may filter as, or more, effectively than a HEPA filtration system while providing benefits of less pressure drop across the filter media and/or lower energy use. For example, at a time of installation, a HEPA system may experience a pressure drop of 2.0 inches of mercury as compared a pressure drop of 0.25 to 0.30 inches of mercury of a DFS or EEF filtration system 300.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification. The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

In addition, logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. An air filtration system comprising:
a housing that defines a first pathway for air to pass from outside the system and through a first plurality of filters, and a second pathway for air to pass from outside the system and through a second plurality of filters, wherein each of the first plurality of filters and the second plurality of filters includes a prefilter and an electrically enhanced filter, the electrically enhanced filter including a high-voltage conductor, a ground grid and filter media disposed between the high-voltage conductor and the ground grid, wherein an electric field is created between the high-voltage conductor and the ground grid when the high-voltage conductor is energized to a high-voltage; and
a fan configured to draw air from outside the system along the first and second pathways.

2. The system of claim 1, wherein the first pathway is opposite to the second pathway.

3. The system of claim 1, wherein the housing further defines a third pathway along which air that has passed along the first pathway through the first plurality of filters and air that has passed along the second pathway through the second plurality of filters is exhausted from within the system to outside the system.

4. The system of claim 3, wherein the third pathway is orthogonal to the first pathway and to the second pathway.

5. The system of claim 1, further comprising one or more power supplies configured for providing a high-voltage to the high-voltage conductor of the electrically enhanced filter of the first plurality of filters and to the high-voltage conductor of the electrically enhanced filter of the second plurality of filters.

6. The system of claim 5, wherein the high-voltage provided to the high-voltage conductors creates a first electric field of greater than 2 kV/cm between the high-voltage conductors and the ground grids.

7. The system of claim 5, wherein the high-voltage provided to the high-voltage conductor creates a first electric field of greater than 2 kV/cm and less than 10 kV/cm between the high-voltage conductors and the ground grids.

8. The system of claim 5,
wherein each of prefilters of the first plurality of filters and of the second plurality of filters includes the high-voltage conductor of the respective plurality of filters, a grounded entry grid, and prefilter media disposed between the high-voltage conductor and the grounded entry grid, and
wherein the high-voltage provided to the high-voltage conductors of the respective plurality of filters creates a first electric field of greater than 2 kV/cm between the high-voltage conductor and the ground grid and creates a second electric field of less than 2 kV/cm between the high-voltage conductor and the grounded entry grid in the respective plurality of filters.

9. The system of claim 8 wherein each of the plurality of filters further includes an intermediate grid located between the high-voltage conductor and the grounded entry grid of the respective plurality of filters, and wherein the intermediate grid is maintained at a voltage that is higher than ground and lower than the voltage on the high-voltage conductor of the respective plurality of filters.

10. A method of filtering air, the method comprising:
in a housing that defines a first pathway for air to pass from outside the housing and through a first plurality of filters, and that defines a second pathway for air to pass from outside the housing and through a second plurality of filters, wherein each of the first plurality of filters and the second plurality of filters includes a prefilter and an electrically enhanced filter, the electrically enhanced filter including a high-voltage conductor, a ground grid and filter media disposed between the high-voltage conductor and the ground grid, applying a high-voltage potential to high-voltage conductor of each of the plurality of filters to create a first electric field between the high-voltage conductor and the ground grid in each of the plurality of filters; and
drawing air from outside the housing along the first and second pathways.

11. The method of claim 10, wherein the first pathway is opposite to the second pathway.

12. The method of claim 10, wherein the housing further defines a third pathway along which air that has passed along the first pathway through the first plurality of filters and air that has passed along the second pathway through the second plurality of filters is exhausted from within the housing to outside the system.

13. The method of claim 12, wherein the third pathway is orthogonal to the first pathway and to the second pathway.

14. The method of claim 10, the first electric field is greater than 2 kV/cm between the high-voltage conductors and the ground grids.

15. The method of claim 14, wherein the first electric field is greater than 2 kV/cm and less than 10 kV/cm between the high-voltage conductors and the ground grids.

16. The method of claim 14,
wherein each of prefilters of the first plurality of filters and of the second plurality of filters includes the high-voltage conductor of the respective plurality of filters, a grounded entry grid, and prefilter media disposed between the high-voltage conductor and the grounded entry grid, and
wherein the high-voltage provided to the high-voltage conductors of the respective plurality of filters creates a second electric field of less than 2 kV/cm between the high-voltage conductor and the grounded entry grid in the respective plurality of filters.

17. The method of claim 16, wherein each of the plurality of filters further includes an intermediate grid located between the high-voltage conductor and the grounded entry grid of the respective plurality of filters, and the method further comprising maintaining the intermediate grid at a voltage that is higher than ground and lower than the voltage on the high-voltage conductor of the respective plurality of filters.
